(19) United States
(12) Patent Application Publication
(10) Pub. No.: US 2009/0113315 A1
(43) Pub. Date: Apr. 30, 2009

(54) Multimedia Enhanced Instant Messaging Engine

(75) Inventors: Roberto Warren Fisher, Los Angeles, CA (US); Lucas Gonze, Venice, CA (US); Eglia Nair Flores, Santa Monica, CA (US); Lisa Fredrickson, Oakland, CA (US); Chris Kalaboukis, Los Gatos, CA (US); Ronald Martinez, San Francisco, CA (US); Ian C. Rogers, Santa Monica, CA (US)

Correspondence Address: BAKER BOTTS L.L.P., 2001 ROSS AVENUE, 6TH FLOOR, DALLAS, TX, 75201, US

(73) Assignee: Yahoo! Inc., Sunnyvale, CA (US)

(21) Appl. No.: 11/925,321

(22) Filed: Oct. 26, 2007

(51) Int. Cl. G06F 3/048

(52) U.S. Cl. 715/758

(57) ABSTRACT

A method to provide additional media objects for two or more users intercommunicating over a network is described. The intercommunication messages are analyzed to determine additional related media objects available on the network, and one or more best related media objects are transmitted to the intercommunicating users. The additional media objects are rendered within the context of the network intercommunication.

### TECHNICAL FIELD

The present disclosure relates generally to distribution of multimedia content over interactive networks, and particularly, to a mechanism for augmenting one or more interactive network instant messages or chats to produce enhanced instant messages or chats containing additional media objects.

### BACKGROUND

As means of communication improve, users of communication devices have an increased ability to consume and disseminate information, and to interact over the network through the sharing of information. This disclosure relates generally to improved means of interacting over the network by sharing media objects among interconnected users.

Modern communication networks are typically hierarchical transmission networks with multiple layers of transmission protocols. A transmission network is a system that allows two or more transceivers to exchange data, whereas a transmission protocol is a sequence of standard interactive steps that facilitate the exchange. Typically, the lowest level protocols are more concretely tied to the interaction of physical circuitry, whereas higher levels of protocols are more abstract to facilitate higher level processing at an algorithmic level. For example, in the vernacular “the web,” also known as “the Internet,” has become shorthand for a multi-layer computer communications system, which combines higher level protocols for access, mid-level protocols, such as a means of locating resources available on the network through a system of uniform resource locators (URLs), and low-level hardware protocols which control the exchange of large, uneven blocks of data by breaking them into smaller, standardized packets. Users seek improved means to gather, transfer, and share multimedia information with other users, without the burden of managing lower-level protocols or learning new programming languages.

Users communicating over a network typically use a physical device, such as a telephone, a text messenger, a cell phone, a personal digital assistant (PDA), a networked music/video player, a personal computer, or a public terminal, to interconnect with other users on the network. The shared information may be conveyed through various forms of media, including text, voice and audio recordings, pictures, animations and movie videos. Network users are able to perform social functions which are analogous to their real world counter-parts, such as to send and receive mail, to chat interactively, or to publish original works or compositions of other works, all in electronic form over the network.

A network user utilizes a number of application programs to create or consume content on the network. Example application programs typically include an “e-mail client,” a “chat client,” a “media object player,” and a “browser”.

A browser is an application program that is generally intended to display “web pages.” A web page is typically a two-dimensional image appearing as an individual page of information including one or more types of contained media. Multimedia content on the network appears in a virtual book format, which typically is displayed as an individually framed “web page” along with means for navigating to other related web pages. The multimedia content may be directly perceived on the web page or may be indirectly accessible. Directly perceived content on the page may include displayed images, videos, or a media object player rendered within the image of the page. Examples of indirect access include access through a pop-up window, through an auxiliary media object player program such as Microsoft's Windows Media Player®, or access provided through a link to the location of another page. Many web pages incorporate one or more “hot links.” The hot link enables a content consumer to access another web page or another application by using a pointing device to locate and click on the link.

An e-mail user typically has the option of accessing electronic mail through a specialized e-mail client application or a general-purpose web browser application. Either application allows a user to compose mail messages as well as to consume messages. E-mail messages typically consist of text and optionally include one or more instances of user-attached media objects. The e-mail messages are typically stored in data objects including text and optionally HTML. To use e-mail, the network user typically registers with an e-mail service-provider, such as Yahoo! Mail®. The service-provider typically maintains a virtual e-mail server for its various service customers' use with e-mail client software. The e-mail server provides a facility for e-mail clients to authenticate themselves and interact with the appropriate subservient server. Users who wish to enhance their e-mails with media objects other than text typically complete a cumbersome process of locating, attaching, and uploading the additional content for the enhanced e-mail.

A chat or instant messaging client is an application program that allows a user to have a nearly real-time conversation with another user on the network. Electronic chat messages typically consist of one or more lines of text. To use a chat program on a computer network, the network user typically registers with a service-provider, such as Yahoo! Chat®. The service-provider typically maintains computer systems on the network responsive to requests for its various services from clients. The user interacts with chat client software to engage other chat users on the network, and the service-provider provides a means for chat clients to authenticate themselves, to initiate an interactive electronic chat conference (or session) among two or more chat clients, and to interact in the chat session.

In the chat session, each individual user typically has a scratch-pad area to compose additional messages. Completed messages are sent as a “chat messages.” Chat messages are typically shared among the various conference participants by consolidating messages in a “chat window.” The window is typically a scrolling two-dimensional display whose contents are updated in real time to present the most recent exchanges as well as a scrolling history of the chat conversation.

Chat users who wish to enhance their chat sessions with media content other than text typically complete a cumbersome process of locating, offering, and transferring the additional content through a side-channel file transfer mechanism. Chat users receiving additional media content must typically accept and download the additional content, and use another application, such as a browser, to view or manipulate the additional downloaded content.

### SUMMARY

A real-time multimedia enhancer for interactive text instant messaging or chat sessions over networks is described. Network chat users access the services of an enhancement service-provider and establish a chat session with one or more other chat clients. In a chat session, users provide one or more text-based chat messages, which are shared among participants in the chat session. The service-provider provides a real-time enhancement mechanism to identify additional media objects related to the chat and available for sharing on the network. The enhancement mechanism modifies the chat conversation to produce enhanced chat conversations, augmented with one or more additional media objects, which are shared among participants in the chat session. Furthermore, additional mechanisms are provided to bias and personalize the selection of additional media objects, to provide user and service-provider control over enhancement mechanisms, and to further identify additional media objects related to those already identified.

### BRIEF DESCRIPTION OF THE DRAWINGS

FIG. 1 is a block diagram of computer system architecture.

FIG. 2 illustrates an example network environment.

FIG. 3 illustrates a client-server system for service registration.

FIG. 4 is a flowchart for an example service registration process.

FIG. 5 illustrates two users chatting over the network.

FIG. 6 illustrates an example unexpanded user interface for text chatting.

FIG. 7 illustrates an expanded multimedia enhancement interface.

FIG. 8 illustrates an example user interface with a single media object player.

FIG. 9 illustrates an example scrolling multimedia chat interface.

FIG. 10 is a flowchart for an example media server process.

FIG. 11 is a flowchart for an example chat server process.

FIG. 12 is a flowchart for an example chat client process interacting with an enhancing server.

FIG. 13 is a flowchart for an example chat client process performing as an enhancing master client.

### DETAILED DESCRIPTION

The following embodiments and aspects thereof are described and illustrated in conjunction with systems, apparatuses and methods which are meant to be exemplary and illustrative, not limiting in scope. In various embodiments, one or more of the above-described problems have been reduced or eliminated.

The following description sets forth numerous details to provide a thorough understanding of various aspects of the present invention. It will be apparent to those skilled in the art, however, that the present invention may be practiced without these specific details. In other instances, algorithms for processing data and symbolic representations of algorithmic operations are the means used by those skilled in the art to most effectively convey the substance of their work to others skilled in the art. An algorithm, as used herein, is a sequence of operations leading to a desired result, said operations requiring physical manipulations of physical quantities. Usually, though not necessarily, these quantities take the form of a sequence of electrical signals representing binary numbers which can be stored, transferred, combined, compared, and otherwise manipulated.

The present invention also relates to apparatus for performing the operations herein. This apparatus may be specially constructed for the required purposes, or it may comprise one or more general-purpose computers selectively activated by one or more computer programs to achieve the required results. Such a computer program may be stored in any suitable computer-readable storage medium. A computer-readable storage medium includes any mechanism for storing or transmitting information in a form that is usable by a machine, such as a general-purpose computer.

The algorithms and displays presented herein are not inherently related to any particular computer or other apparatus. Various general-purpose systems may be used in accordance with the teachings herein, and it may prove expedient to construct more specialized apparatus to perform the algorithm operations. The required structure for a variety of these systems may appear from the description below. In addition, the present invention is not described with reference to any particular programming language. Those skilled in the art will appreciate that a variety of programming languages may be used to implement the teachings of the invention as described herein.

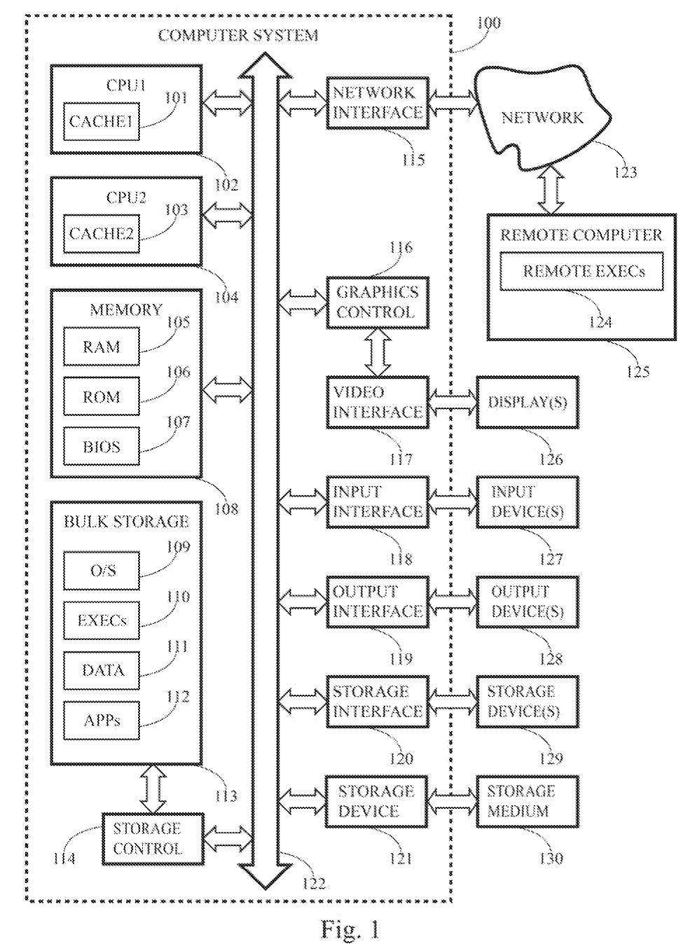

Server and client systems described herein can be implemented by a variety of computer systems and architectures. FIG. 1 illustrates suitable components in an exemplary embodiment of a general purpose computer system. The exemplary embodiment is only one example of suitable components and is not intended to suggest any limitation as to the scope of use or functionality of the invention. Neither should the configuration of components be interpreted as having any dependency or requirement relating to any one or combination of components illustrated in the exemplary embodiment of a computer system. The invention may be operational with numerous other general purpose or special purpose computer system environments or configurations.

The invention may be described in the general context of computer-executable instructions, such as program modules, being executed by a computer. Generally, program modules include routines, programs, objects, components, data structures, and so forth, which perform particular tasks or implement particular abstract data types. The invention may also be practiced in distributed computing environments where tasks are performed by remote processing devices that are linked through a communications network. In a distributed computing environment, program modules may be located in local and/or remote computer storage media including memory storage devices.

With reference to FIG. 1, an exemplary system for implementing the invention may include a general purpose computer system 100. Computer system 100 accesses one or more applications and peripheral drivers directed to a number of functions described herein. Components of the computer system 100 may include, but are not limited to, a CPU or central processing unit 102, a system memory 108, and a system bus 122 that couples various system components including the system memory 108 to the processing unit 102. As used by those skilled in the art, a signal “bus” refers to a plurality of digital signal lines serving a common function. The system bus 122 may be any of several types of bus structures including a memory bus, a peripheral bus, and a local bus using any of a variety of bus architectures. By way of example, and not limitation, such architectures include Industry Standard Architecture (ISA) bus, Enhanced ISA (EISA) bus, Micro Channel Architecture (MCA) bus, Video Electronics Standards Association local (VLB) bus, Peripheral Component Interconnect (PCI) bus, PCI-Express bus (PCI-X), and Accelerated Graphics Port (AGP) bus.

An operating system manages the operation of computer system 100, including the input and output of data to and from applications (not shown). The operating system provides an interface between the applications being executed on the system and the components of the system. According to one embodiment of the present invention, the operating system is a Windows® 95/98/NT/XP/Vista/Mobile operating system, available from Microsoft Corporation of Redmond, Wash. However, the present invention may be used with other suitable operating systems, such as an OS-X® operating system, available from Apple Computer Inc. of Cupertino, Calif., a UNIX® operating system, or a LINUX operating system.

The computer system 100 may include a variety of computer-readable media. Computer-readable media can be any available media that can be accessed by the computer system 100 and includes both volatile and nonvolatile media. For example, computer-readable media may include volatile and nonvolatile computer storage media implemented in any method or technology for storage of information such as computer-readable instructions, data structures, program modules or other data. Computer storage media includes, but is not limited to, random access memory (RAM), read-only memory (ROM), electrically erasable programmable ROM (EEPROM), flash memory or other memory technology, compact-disk ROM (CD-ROM), digital versatile disks (DVD) or other optical disk storage, magnetic tape cassettes, magnetic tape, hard magnetic disk storage or other magnetic storage devices, floppy disk storage devices, magnetic diskettes, or any other medium which can be used to store the desired information and which can accessed by the computer system 100.

Communication media may also embody computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. For instance, communication media includes wired media such as a wired network or direct-wired connection, and wireless media such as acoustic, RF, infrared, cellular networks, and other wireless media.

The system memory 108 includes computer storage media in the form of volatile and/or nonvolatile memory such as read only memory (ROM) 106 and random access memory (RAM) 105. A basic input/output system 107 (BIOS), containing the basic routines that help to transfer information between elements within computer system 100, such as during start-up, is typically stored in ROM 106 and other non-volatile storage, such as flash memory. Additionally, system memory 108 may contain some or all of the operating system 109, the application programs 112, other executable code 110 and program data 111. Memory 108 typically contains data and/or program modules that are immediately accessible to and/or presently being operated on by CPU 102. Optionally, a CPU may contain a cache memory unit 101 for temporary local storage of instructions, data, or computer addresses.

The computer system 100 may also include other removable/non-removable, volatile/nonvolatile computer storage media. By way of example only, FIG. 1 illustrates a bulk storage 113 that reads from or writes to one or more magnetic disk drives of non-removable, nonvolatile magnetic media, and storage device 121 that may be an optical disk drive or a magnetic disk drive that reads from or writes to a removable, a nonvolatile storage medium 130 such as an optical disk or a magnetic disk. Other removable/non-removable, volatile/nonvolatile computer storage media that can be used in the exemplary computer system 100 include, but are not limited to, magnetic tape cassettes, flash memory cards, digital versatile disks, digital video tape, solid state RAM, solid state ROM, and the like. Bulk storage 113 and the storage device 121 may be connected directly to the system bus 122, or alternatively may be connected through an interface such as storage controller 114 shown for bulk storage 113. Storage devices may interface to computer system 100 through a general computer bus such as 122, or may interconnect with a storage controller over a storage-optimized bus, such as the Small Computer System Interface (SCSI) bus, the ANSI ATA/ATAPI bus, the Ultra ATA bus, the FireWire (IEEE 1394) bus, or the Serial ATA (SATA) bus.

The storage devices and their associated computer storage media, discussed above and illustrated in FIG. 1, provide storage of computer-readable instructions, executable code, data

[symbol]

A user may enter commands and information into the computer system 100 through the network interface 115 or through an input device 127 such as a keyboard, a pointing device commonly referred to as a mouse, a trackball, a touch pad tablet, a controller, an electronic digitizer, a microphone, an audio input interface, or a video input interface. Other input devices may include a joystick, game pad, satellite dish, scanner, and so forth. These and other input devices are often connected to CPU 102 through an input interface 118 that is coupled to the system bus, but may be connected by other interface and bus structures, such as a parallel port, a game port or a universal serial bus (USB). A display 126 or other type of video device may also be connected to the system bus 122 via an interface, such as a graphics controller 116 and a video interface 117. In addition, an output device 128, such as headphones, speakers, or a printer, may be connected to the system bus 122 through an output interface 119 or the like.

The computer system 100 may operate in a networked environment using a network 123 to one or more remote computers, such as a remote computer 125. The remote computer 125 may be a terminal, a personal computer, a server, a router, a network PC, a peer device or other common network node, and typically includes many or all of the elements described above relative to the computer system 100. The network 123 depicted in FIG. 1 may include a local area network (LAN), a wide area network (WAN), or other type of network. Such networking environments are commonplace in offices, enterprise-wide computer networks, intranets and the Internet. In a networked environment, executable code and application programs may be stored in the remote computer. By way of example, and not limitation, FIG. 1 illustrates remote executable code 124 as residing on remote computer 125. It will be appreciated that the network connections shown are exemplary and other means of establishing a communications link between the computers may be used.

Collectively, these elements are intended to represent a broad category of computer systems, including but not limited to general purpose computer systems based on one or more members of the family of CPUs manufactured by Intel Corporation of Santa Clara, Calif., the family of CPUs manufactured by Advanced Micro Devices (AMD), Inc., of Sunnyvale, Calif., or the family of ARM CPUs, originally designed by Advanced RISC Machines, Ltd., as well as any other suitable processor. Of course, other implementations are possible. For example, the server functionalities described herein may be implemented by a plurality of server sub-systems communicating over a backplane.

Various components of computer system 100 may be rearranged, deleted, or augmented. For example, system bus 122 may be implemented as a plurality of busses interconnecting various subsystems of the computer system. Furthermore, computer system 100 may contain additional signal busses or interconnections between existing components, such as by adding a direct memory access unit (not shown) to allow one or more components to more efficiently access system memory 108.

As shown, CACHE1 and CPU1 are packed together as “processor module” 102 with processor CPU1 referred to as the “processor core.” Alternatively, cache memories 101, 103, contained in 102, 104 may be separate components on the system bus. Furthermore, certain embodiments of the present invention may not require nor include all of the above components. For example, some embodiments may include a smaller number of CPUs, a smaller number of network ports, a smaller number of storage devices, or a smaller number of input-output interfaces. Furthermore, computer system 100 may include additional components, such as one or more additional central processing units, such as 104, storage devices, memories, or interfaces. In addition, one or more components of computer system 100 may be combined into a specialized system-on-a-chip (SOC) to further system integration. In some computer system environments where component count is critical, the entire computer system may be integrated in one or more very large scale integrated (VLSI) circuit(s).

As discussed below, in one implementation, operations of one or more of the physical server or client systems described herein is implemented as a series of software routines executed by computer system 100. Each of the software routines comprises a plurality or series of machine instructions to be executed by one or more components in the computer system, such as CPU 102. Initially, the series of instructions may be stored on a storage device, such as bulk storage 113. However, the series of instructions may be stored in an EEPROM, a flash device, or a DVD. Furthermore, the series of instructions need not be stored locally, and could be received from a remote computer 125 or a server on a network, via network interface 115.

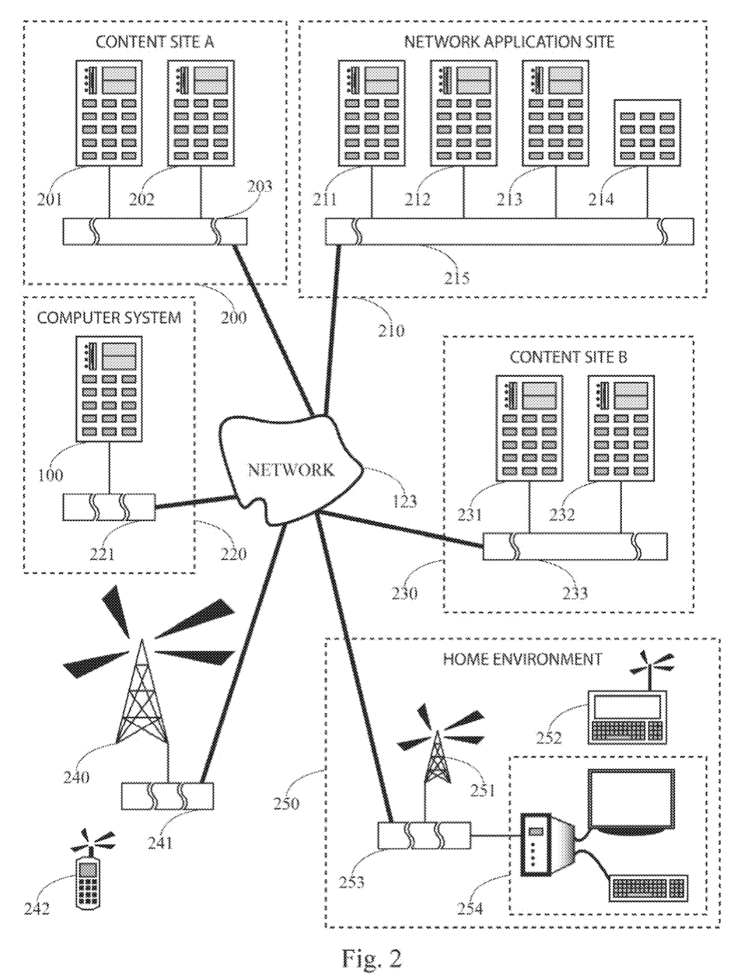

FIG. 2 illustrates computer system 100 placed in an example wide area network environment, such as the Internet. Network cloud 123 generally represents one or more interconnected networks, connecting computer system 100, a plurality of network sites, 200, 210, 220, 230, 240, and 250, and a plurality of client devices, 242, 251, 252, and 254. Network cloud 123 may include TCP/IP based wide area networks, private networks, wireless networks, satellite networks, cellular networks, paging networks, and the like. Client systems, such as portable device 242, portable computer 252, and personal computer 254 are operably connected to the wide area network environment through an internet service provider (not shown), a cellular provider 240, a wireless provider (not shown), a local wireless network 251, and/or a local wired network 253.

Computer system 100 is contained within the network site 220, where one or more computer systems, such as computer system 100, are connected to a local area network and router 221. The router 221 manages local computer communication traffic in network site 220 and interconnects with network cloud 123. Router 221 also functions to translate one or more local area network addresses in network site 220 to provide one or more unique corresponding wide area network addresses in order to facilitate communication between computer systems in network site 220 and other computer systems on the wide area network.

FIG. 2 illustrates a number of network service provider sites, including content site A 200, content site B 230, and network application site 210. The described invention may operate with one or more content providing or application sites. Although FIG. 2 illustrates the provider sites as separate local network sites, the functionality of each site may be combined with other sites. Further, a function for a particular site may be performed in a distributed computing environment by one or more computer systems at remote sites. Further still, the functionality represented by each depicted site may be further separated into a plurality of sub-function sites. In addition, implementations of the invention may operate in network environments that include multiples of one or more of the individual sites or subsystems of sites described herein. Implementations of the invention may also operate in network environments where one of more of the systems or sites described herein has been eliminated.

Content aggregation sites are represented by content site A 200 and content site B 230 in FIG. 2. Content is stored as one or more digital data objects. A digital data object may include one or more media objects or executable code objects. Content site A 200 is a network addressable system that allows users to access media objects supplied by one or more users. In one implementation, content site A 200 may be a media object aggregation or sharing system, such as Yahoo! Flickr® photo sharing site, and similar variants. Content site A 200 comprises one or more physical server systems 201, 202, implemented using an architecture such as that of computer system 100, and containing or connected to one or more bulk storage systems, such as that of bulk storage system 113, or a network attached storage device (not shown), and a local area network and router 203. The one or more physical servers allow users to upload and download media objects. In one implementation, the functionality hosted by the one or more physical servers may include web or HTTP servers, FTP servers, and the like.

Content site B 230 is a network addressable system that allows users to access content supplied by one of more content suppliers (not shown). Content site B 230 comprises one or more physical server systems 231, 232 containing or connected to one or more bulk storage systems (not shown), and a local area network and router 233. The one or more physical servers 231, 232 allow the service provider (not shown) to store media objects and users to download media objects.

Network application site B 210 is a network addressable system that allows users to access one or more executable code objects supplied by one or more service providers (not shown). Network application site B 210 comprises one or more physical server systems 211, 212, 213 containing or connected to one or more bulk storage systems, shown as network-attached storage device 214, and a local area network and rooter 215. Executable code objects may include code to be executed on a client device as well as code executed within a server system, such as server 212. An example of an executable code object is an informational web site where users request and receive identified web pages and other content over the network cloud 123. The executable code object may also be a posting forum, where users may submit or otherwise configure media objects to be perceived by other users. The executable code object may also be a social network application, such as a chat client or e-mail client, adapted to establish intermediated or peer-to-peer communications with other clients. The executable code object may also be a web-posting application, allowing users to configure and maintain personal web pages. One or more executable code objects may also combine to form a content distribution application that displays available media objects and transmits them to users. Examples of network application sites include Yahoo! Music Engine®, Apple iTunes®, and podcasting servers.

In media object aggregation or sharing systems, such as the Yahoo! Flickr® photo sharing site, media objects are typically contained in data objects which also contain metadata related to the media object. For example, a data object containing a media object may also contain one or more meta keywords or tags to identify related media objects. A photo sharer may upload a photo to a photo sharing site, and consider the photo related to a set of keywords, such as “artists,” “musicians,” “drummers,” and “teen-idols.” The photo sharer may further configure the media object by combining the media object with the set of related meta parameters in a data object.

In the context of a computer network, a “virtual server” is physically one or more server systems connected to the network and support circuitry to execute application programs which process data. Data may be stored by means which facilitate efficient processing, such as by storing the data in a “database” consisting of a collection of data organized by relationships between the various forms of data contained therein. When a virtual server consists of more than one computer server system, the set of computer server systems is interconnected hierarchically to perform high-level functions as combined functions of several servers under central control.

Functionally, a virtual server executes a sequence of low-level CPU commands to complete instructions for processing data. A virtual server typically accepts instructions and executes commands for a multitude of “clients”. The instructions may include, but are not limited to, instructions to store or retrieve data, to modify, verify or erase data, or to reorganize data. A virtual server may also initiate instructions for other network-attached devices. For example, a virtual “music server” might maintain a database to locate a library of musical compositions. The music server might receive commands to store new songs or retrieve old ones from a number of clients. Further, the music server might send commands to other devices on the network, e.g., to disseminate the musical database among various subservient servers, such as a “jazz server,” a “hip-hop server,” a “classical server,” and so on, to register paying user requests in a “billing server,” to verify the identity, preferences, and access privileges of a user in a “registration server” and so on. The music server may therefore also be a client of other servers. Practitioners of the art will recognize that virtual servers and clients are abstract interactive devices controlled by software instructions, whose interaction protocols may be flexibly defined. A “client” as used herein may include functionally to process information and programs, as well as to issue commands. Similarly, a virtual server as used herein may include functionally to initiate commands to users and other servers as well as to respond to instructions.

Similarly, a database should not be construed to be a single physical collection of data. As used herein, a database is an abstract collection of data which may be distributed over one or more physical locations. Said data may be stored physically within a single or multiple servers, within attached physical device(s), network attached device(s), or user devices(s). Similarly, an application program should not be construed to be a single physical collection of commands. As used herein, an application program is an abstract collection of CPU commands, which may be physically executed, in whole or in part, within a single or multiple servers, within attached physical devices(s), within network attached device(s), or within user device(s).

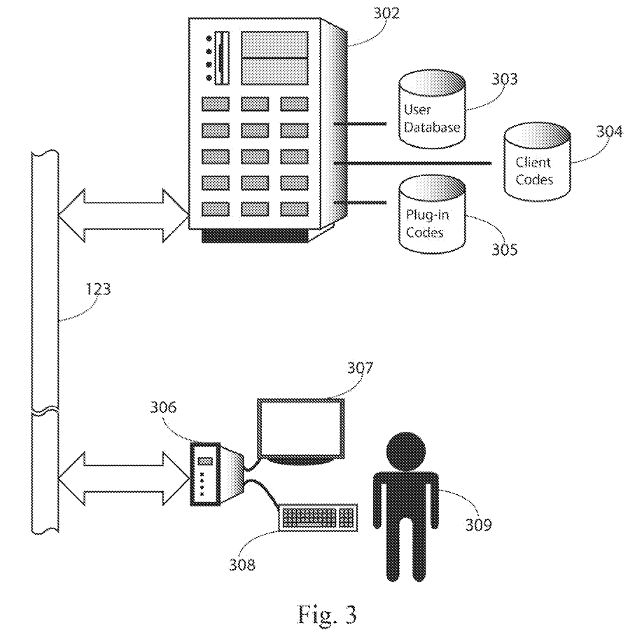

FIG. 3 illustrates a client-server system, where an enhancement service-provider registers a plurality of users. User 309 is able to communicate over the network 123 through the use of a network client application, such as a web browser. User 309 typically has a network access device 306, such as a computer, a text input device 308, such as a keyboard, and observes a two-dimensional display 307, such as a monitor. The enhancement service-provider operates a virtual registration server 302 over the network 123 which maintains a registration website (not shown), a database of user identities 303 and a plurality of databases of computer software code 304, 305 to enable network users to access an enhancement service. Server 302 is operative to register new users and to supply appropriate software code.

Server 302 implements a registration process which may include one or more of (1) determining whether the user is a new or a returning user, (2) authenticating the returning users, (3) storing a set of user attributes, (4) accessing a set of user attributes, (5) enabling use of the enhancement service by providing one or more software codes; and/or (6) maintaining a presence system that facilitates intermediated and/or peer-to-peer interactive instant message or chat sessions.

In FIG. 3, the software codes are distinguished as chat client codes, contained in database 304, and plug-in codes, contained in database 305. The plug-in codes are operative to install a plug-in operating within the context of a general-purpose or special-purpose client application, such as an existing chat client, instant messaging client, or a web browser. The plug-in is operative to functionally replace, augment, or modify a user application program, such as a browser, to enable one or more additional enhancement steps in the composition or rendering of media objects. A chat client code module is operative to install a stand-alone chat client application for one or more user devices.

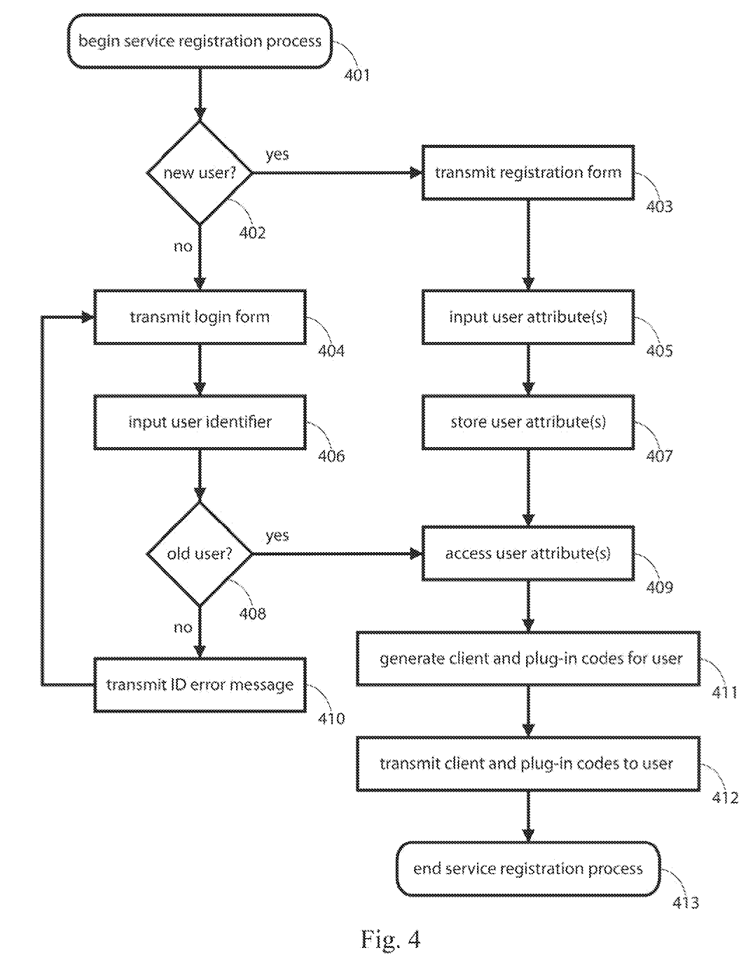

FIG. 4 is a flowchart representing an example service registration process consisting of a number of software steps. Components in a service-provider's registration server 302 execute computer-readable instructions to implement the software steps. The registration process scans user input to determine whether a user accessing the server is a new user in step 402. For new users, the registration process scans entries on an online registration form, transmitted in step 403, to input, in step 404, and store, in step 405, one or more user attributes including a unique user identifier (ID) in the user database 303. Optionally, the registration server executes commands to incorporate user privileges and/or preferences in the stored user attributes.

For new users, the output of the service registration process is operative to provide a media enhancement mechanism for the user's preferred chat client. The user may prefer to install software code resulting in a stand-alone chat client application, or may prefer to augment or modify the functionality of an existing chat client application by installing a “plug in” software code to work in conjunction with the existing chat application.

The software codes are operative to facilitate the enhancement mechanism. The chat-enhancement mechanism attaches one or more media objects to a text chat session or instant message. The software codes may further facilitate the chat-enhancement mechanism by providing augmented rendering capability for media objects. Once installed on a client device, the chat-enhancement mechanism may be automatically invoked when the chat client application is initiated. In step 407, registration server 302 retrieves, and in some instances, dynamically generates a set of appropriate chat client and/or plug-in codes for the user, and transmits the codes to a user device 306 in step 408. For dynamically generated code, the server may dynamically add one or more user attributes, such as a user identifier, to the code. The user attributes may relate to one or more parameters pertinent to the operation of the enhancement mechanism. For example, the user attributes may include parameters that bias or control selection of photographic media objects over video/audio media objects. These parameters can be used to further bias the selection of media, as described below, to allow for composer or consumer personalization.

After the software has been installed, the user may activate the registration process as a returning user. The registration process authenticates returning users by scanning input, in step 410, to an online login form, transmitted in step 409, to determine if the login ID resides in the user database 303 in step 411. The user may optionally be further identified by use of a password or other authentication method. If the scanned user input information does not correspond to a user database entry, an error message is transmitted in step 412, and the user may re-enter login information in steps 409, 410.

Once a user has been properly identified, the user ID and optionally one or more other user attributes are optionally transmitted to one or more chat servers performing as presence servers in step 413. Each of said presence servers is operative to indicate the presence of one or more chat client users available on the network, in order to facilitate the initiation of instant messaging sessions between two or more users. Optionally, the user attributes may include a list of authorized instant messaging partners (or chat buddies) for the user. The presence server may by further operative to transmit the user's online presence to the list of authorized instant messaging partners in step 414.

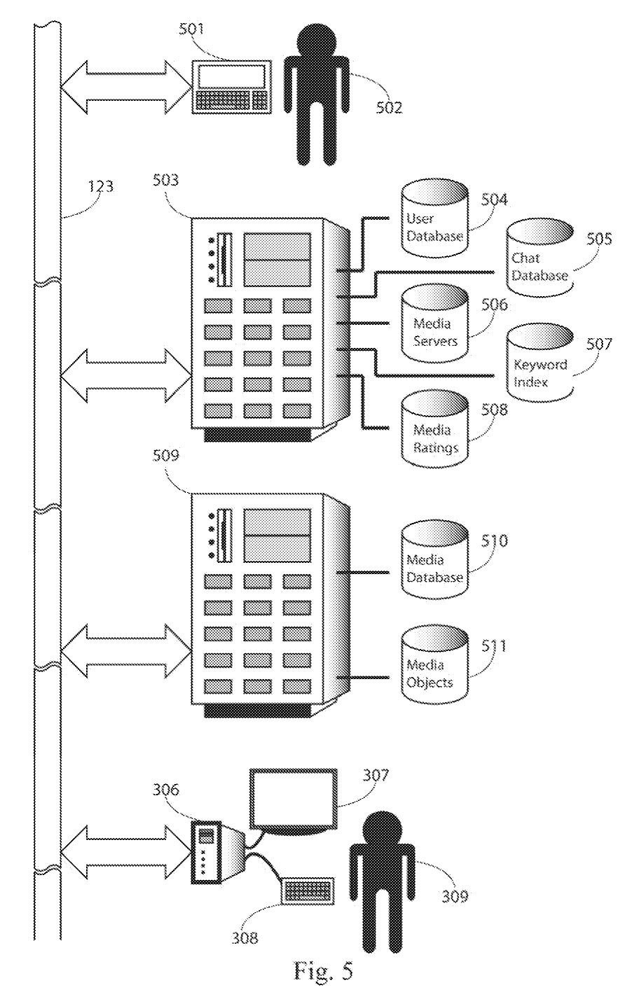

Referring to FIG. 5, user 309 is chatting with or sending an instant message to another user 502. A laptop computer or similar computing device 501 is used to connect user 502 to network 123. An instant message service provider operates chat server 503 connected to network 123, and a media object supplier operates media server 509, also connected to network 123. Interaction of the various components of FIG. 5 is dependent on the user mode of operation, as described below.

In FIG. 5, chat server 503 accesses a number of example databases 504-508. User database 504 contains a collection of records of user identity and optionally, corresponding descriptive user parameters, such as geographic location and subscription status. Chat database 505 is a collection of records of currently operating chat sessions. Media server database 506 is a collection of records describing servers which supply media objects. Keyword index database 507 is a collection of records of one or more characterizing tags or attributes that may be associated with a media object. Media ratings database 508 is a collection of records that rate a media object relative to one or more associated attributes, such as popularity among media object consumers.

In FIG. 5, media server 509 accesses a number of example databases, 510-511. Media descriptor database 510 is a collection of records describing media objects provided by the media server. The records include one or more descriptions of media object attributes, such as the media type, a preferred media object player for the media object, date of creation, the physical location of the media object, and the like. Media object database 511 contains a collection of files corresponding to the media objects in a format suitable for communication over the network.

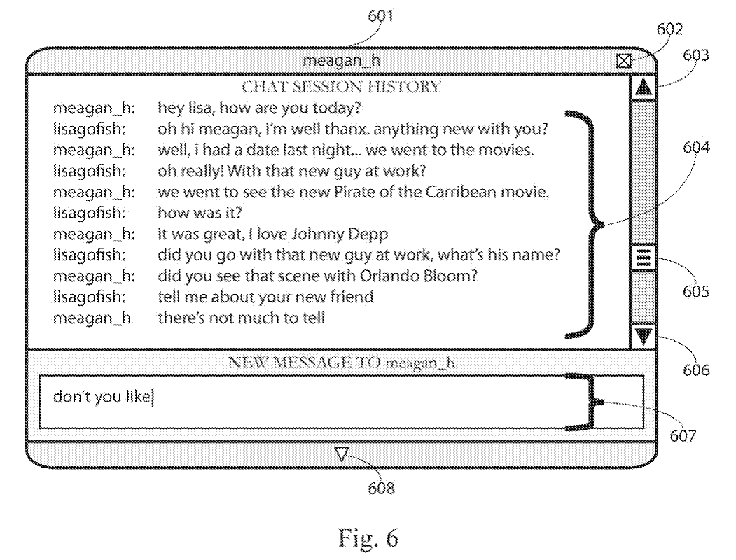

FIG. 6 illustrates a portion of a chat session between users 309 and 502, as seen by user 309. The users are identified by “handles” assigned at registration. In FIG. 6, user 502 is identified as “meagan_h” while user 309 is identified as “lisagofish.” When a user initiates a chat session, a chat window with a title bar 601 identifying the other user appears on each chat user's display. A user may end a chat session at any time by clicking in a “close box” 602 of the chat window.

The sequential chat messages 604 are typically presented in book order, reading from left to right and top to bottom. Each user is able to observe a user-selectable portion of the shared chat messages, shown as “CHAT SESSION HISTORY” 604. A scrollbar mechanism is provided by up-scroll arrow 603, scroll-down arrow 606, and slider 605. The vertical location of slider 605 indicates an approximate current location in a scrolling history of chat messages. If a user desires to look backwards in time at the chat conversation, the user may click on the up-scroll arrow 603 or drag the slider 605 upwards, using a pointing device. Similarly, if a user desires to look forward in time at the chat conversation, the user may click on the down-scroll arrow 606 or drag the slider 605 downwards.

User 309 may compose a chat message to add to the chat session in scratch area 607. Typically, the scratch area is only visible to the composing user, and allows the user to modify a future chat message. When the user is satisfied with the message composition, the user may types a “RETURN” or “ENTER” character (not shown) to complete the message. A completed message is appended to the scrolling message history 604, and the shared chat message history window contents are updated for both users.

In one embodiment of the current invention, a user may manually augment a chat session by interacting with one or more user interface controls, such as expand button 608 of FIG. 6. In an example manual mode, the user engages a chat enhancement interface control, such as by clicking on button 608, to interact with the chat message enhancement mechanism. Activation of the enhancement mechanism may initiate an automatic enhancement based on one or more chat messages, such as a recent chat message, the chat session as a whole, or on a particular portion of the chat session as indicated by the user. Alternatively, activation of the enhancement mechanism may further expand on a number of manually adjusted options for the enhancement process.

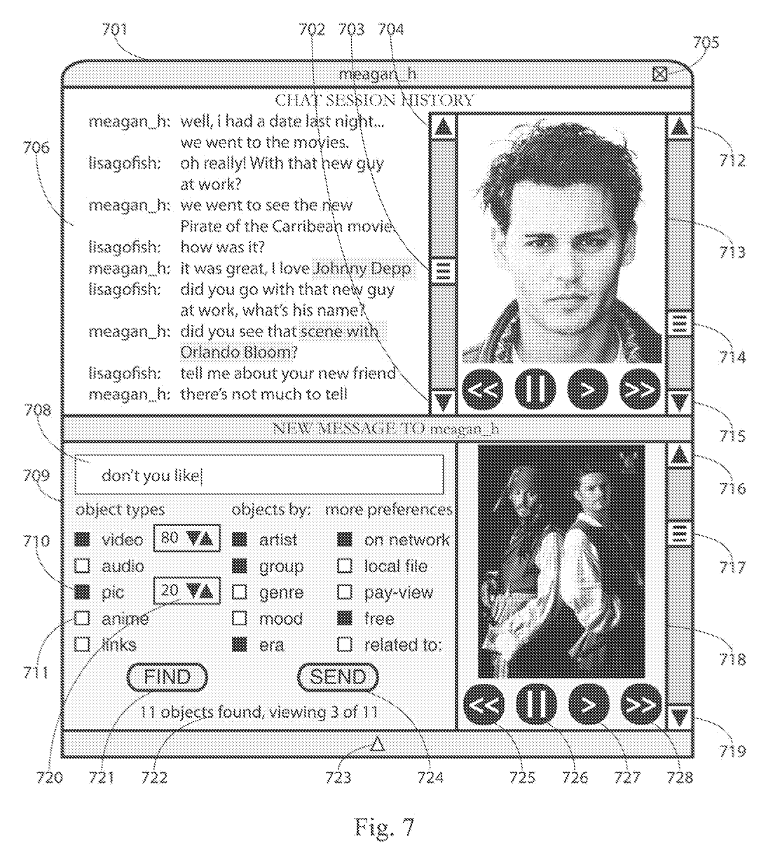

An example of an expanded multimedia chat window is shown in FIG. 7. In analogy with FIG. 6, FIG. 7 contains an upper portion dedicated to “CHAT SESSION HISTORY” and a lower portion dedicated to composing new messages. The chat session history contains a history of shared media objects as well as the shared text messages. As before, the text message history portion has a history scrollbar, with up-arrow 702, slider 703, and down-arrow 704. The history of shared media objects is accessed using media object player 713 and media object history scrollbar, with up-arrow 712, slider 714, and down-arrow 715. A representation of a currently accessed media object appears on the media object player 713. Each user is able to observe a user-selectable portion of the shared media objects. The vertical location of slider 714 indicates an approximate current location in timeline of shared media objects. If a user desires to look backwards in time at an earlier shared media object, the user may click on the up-scroll arrow 712 or drag the slider 714 upwards, using a pointing device. Similarly, if a user desires to look forward in time at a later shared media object, the user may click on the down-scroll arrow 715 or drag the slider 714 downwards.

The lower portion of FIG. 7 allows a user to compose a future text message and to determine a future media object to be shared. Text composition pane 708 allows the user to compose new text messages. The remainder of the lower portion of the chat window is dedicated to selecting one or more additional media objects.

In one embodiment of the invention, the user has an ability to influence the selection of additional media objects by indicating a number of user preferences. In one alternative, the user preferences are designated in a separate preference menu (not shown). In another alternative, the user is able to adjust selection preferences with each request for an additional media object. An example interface pane for selection of user preferences for this purpose is shown in 709. The preferences may be grouped into categories, such as preferred media object type (e.g. video, audio, pictures, and the like), preferred attributes of additional media objects (e.g. media objects related to the chat conversation by artist or group, by genre, by mood, and/or by era, and the like), and other miscellaneous attributes (such as restrictions to media objects which can be found on the network, which can be found on the user's device, objects which can only be viewed with a subscription fee, objects which may be viewed freely, or media objects related to previously found media objects, and so on). In this example interface, the user selects a preference by clicking on an associated box 710, and the preference pane reflects the user selection, such as by darkening the box. Additionally, the user may influence the relative weighting of preferences, such as by using weighting factors adjusted numerically in adjuster 719. In this example weighting, the user prefers 80% video media objects and 20% pictures. By clicking on an up or down arrow in adjuster 719, the user may change the relative importance of these preferences and change the mix of additional media objects.

As stated above, the additional media objects are related to the chat conversation or previously shared media objects. The additional media objects may be selected by processing the chat conversation as a whole, or by processing a subset of the chat conversation. In one embodiment, the user may further indicate which portions of the chat conversation should be considered relevant to the additional media object selection process. In FIG. 7, the phrases “Johnny Depp” and “scene with Orlando Bloom” have been highlighted, such as, for example, by dragging the user cursor through a portion of text using a pointing device, to indicate that these phrases should be considered most relevant to the selection of additional media objects. As indicated below, selection of relevant portions of the chat conversation may also be embodied in an automated selection process. An example automated process might provide media objects related only to the future message, the last shared message or last few shared messages of the chat conversation.

When the user is satisfied with the additional media object selection preferences, the user initiates a search for additional media objects. In this example interface, the user clicks on the FIND button 720 of FIG. 7 to initiate the search. In response, a number of background processes occur as described below to process the user request and search for additional media object(s). More than one additional media object may be found in a search. The status of the search request may be indicated as shown on example status line 721. In this example, eleven additional media objects were found.

In one embodiment, an additional media object player 718 is displaying a representation of a currently found media object which can be observed by user 309. The scrollbar mechanism consisting of up arrow 716, slider 717, and down arrow 719 allows the user to select one of the other ten additional media objects found. Slider 717 indicates the location of the additional media object displayed in the timeline of additional media objects found. In the example status line 721, the user is redundantly informed that this is the third of eleven objects found.

In the example of FIG. 7, the additional media object is a video clip of Pirates of the Caribbean with actors Orlando Bloom and Johnny Depp. In one embodiment, a media object player interface incorporates controls 725-728. Control 725 is used to rewind the video, 726 pauses the video, 727 plays the video, and 728 fast-forwards the video. When user 309 finds a media object of an audio or video recording, play button 727 allows the recording to be played. When a different type of media object, such as a picture, is examined, the media player interface controls change to those appropriate for the media object type. In one embodiment, the media control interface buttons which are appropriate for the media object are darkened, whereas inappropriate media player controls are dimmed (not shown).

When user 309 decides to share a found media object, SEND control 724 is activated to initiate a transfer of the media object to the shared chat session history observed by both users, and, in particular, the shared media object history is updated. User 309 observes the updated media object history in media object player 713. In this manner, user 309 may select various chat phrases, various preferences, and a previously located media object to influence the search for additional media objects. In analogy with the text composition mechanism of FIG. 6, the enhancement mechanism allows the user to preview and modify the future additional media object message until the user is satisfied. When user 309 is satisfied with a search result, the additional media object may be readily shared with other chat participants, without resorting to a side-channel transfer mechanism.

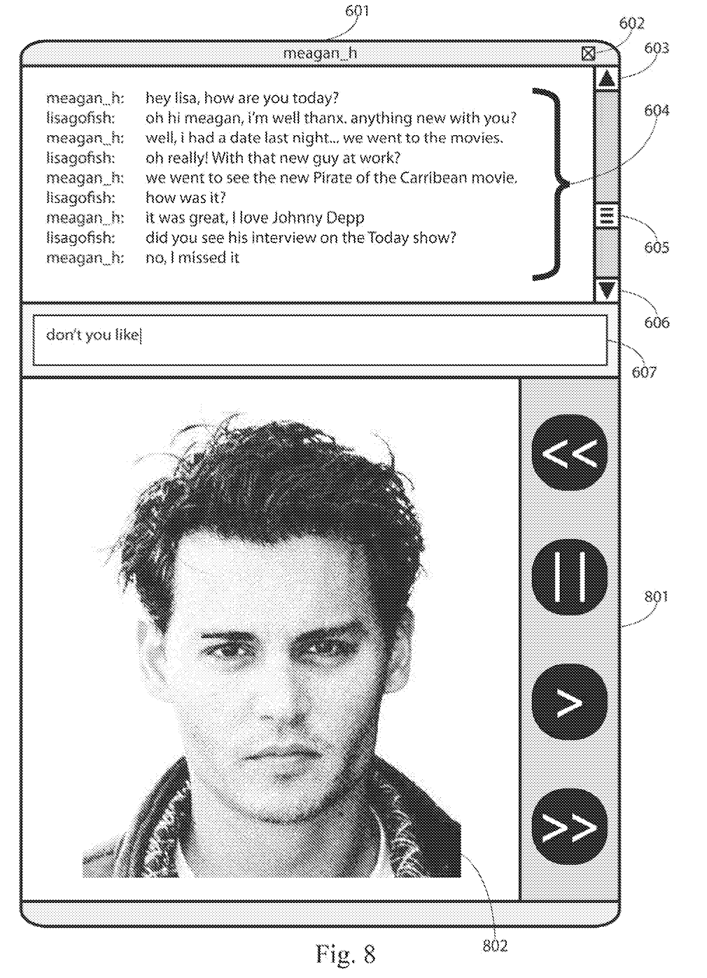

FIG. 8 shows an alternative interface for the invention. FIG. 8 contains an upper portion of FIG. 8 labeled analogously to FIG. 6. The upper portion contains a scrolling chat message display 604, future message composition area 607, and a mechanism for scrolling through the chat history 603, 605, and 606. Each chat session, participant observes a single media object player, such as 801, displaying a representation of a common additional media object 802. In one embodiment, an automated text and media object enhancement mechanism processes one or more recent text messages and/or a recently displayed media object to find the additional media object 802. In an alternative embodiment, one or more participants in the chat conversation is designated as the current finder of additional media objects, and the remaining participants are merely observers of the additional media objects, with an example interface as shown in FIG. 8. This alternative embodiment may be particularly useful in certain types of web meetings, where, for example, a project leader or presenter displays media objects related to a project, and other participants are limited to a textual discussion of the project.

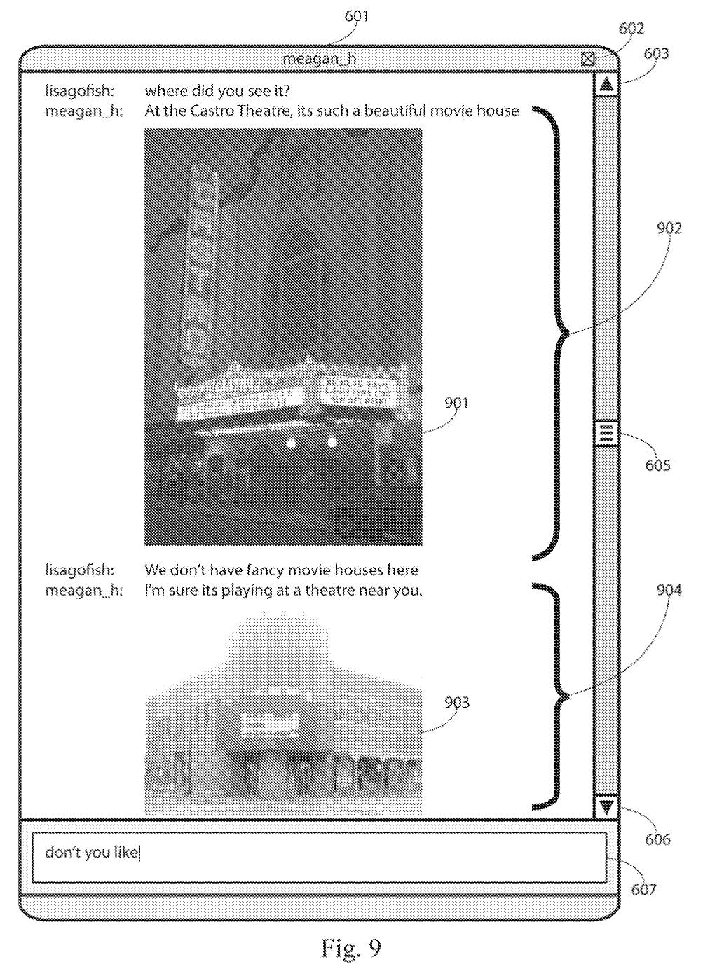

FIG. 9 shows a third alternative embodiment of an interface for the invention. In this embodiment, one or more additional media objects is inserted in the scrolling chat session. In this example, user 502 describes a theatre in text. An example background enhancement process locates an additional media object consisting of a picture of the theatre 901 and appends the chat history with the relevant message combined with the additional media object 902. In this example, user 502's description names a specific subject, “the Castro Theatre,” of the additional media object. In text message 904, user 502 refers to a non-specific object, “a theatre near you.” As described below, the text enhancement mechanism may incorporate identifiers of attributes of the sending or receiving user. In this example, the text enhancement mechanism recognizes “near you” as a desired geographic attribute of the additional media object, accesses the attributes of the receiving user to determine her geographic location, and displays an additional media object which is personalized for the receiving user.

A particular application of the current invention is to supply additional media objects consisting of advertising. This application is illustrated in two examples in FIG. 9. A common method of advertising is through product placement, designed to stimulate consumer demand by displaying other consumer's use of the product. As can be observed in picture 901, the example displayed theatre contains a marquee. Sending user 502 specifically requested a media object related to the theatre, and the request has been fulfilled, and it is likely that user 502 would be satisfied regardless of which text is displayed on the marquee. As such, the media object may be manipulated to advertise or suggest a certain product to a receiving user by inclusion of a representation of the product in the additional media object. In this example, a movie advertisement may be inserted in the additional media object by altering the displayed text on the marquee.

Another common means of advertising is to display ads. In FIG. 9, both user 309 and 502 may be unaware of a specific local theatre showing the movie which is the subject of the chat. As discussed above, the additional media object of 904 may be an advertisement for a local theatre showing the movie. Users may desirably consume a product whose availability is indicated by an additional media object consisting of advertising.

Surveys have shown that consumers are more likely to consume products favored by people they know. Suppose that user 502 is an observer of additional media objects supplied by user 309 and the enhancement service provider as discussed above. An advantage of the enhancement mechanism as shown in FIG. 9 is that it becomes difficult for user 502 to distinguish which additional media objects are supplied by another chat participant, and whether an additional media object contains a product placement. As such, the display of FIG. 9 may favorably create an impression for the advertiser that one or more displayed products are favored by another chat participant.

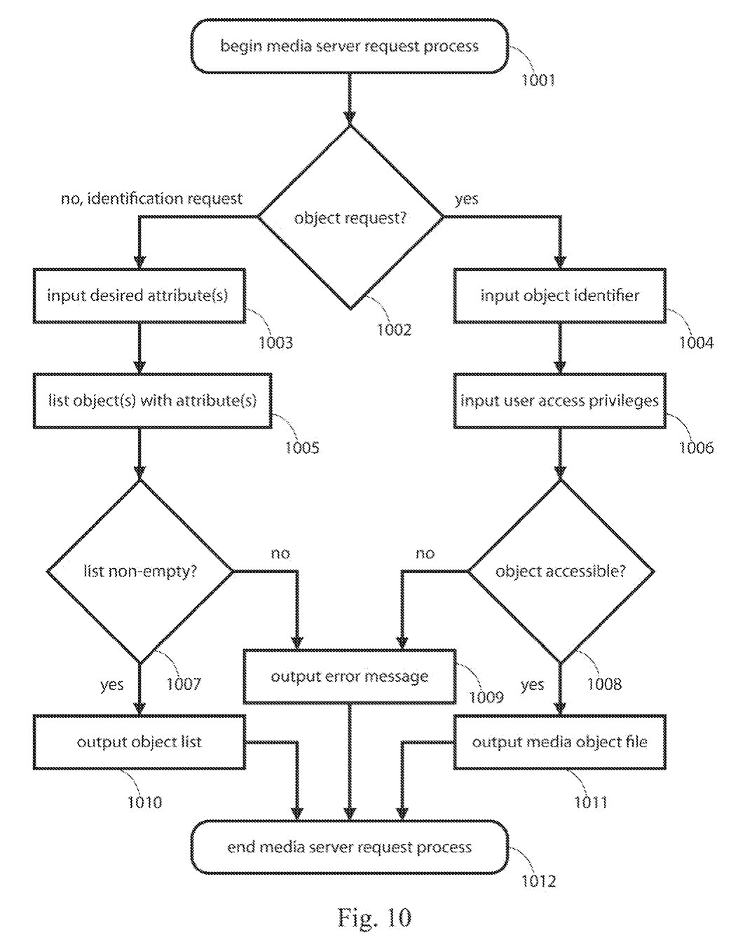

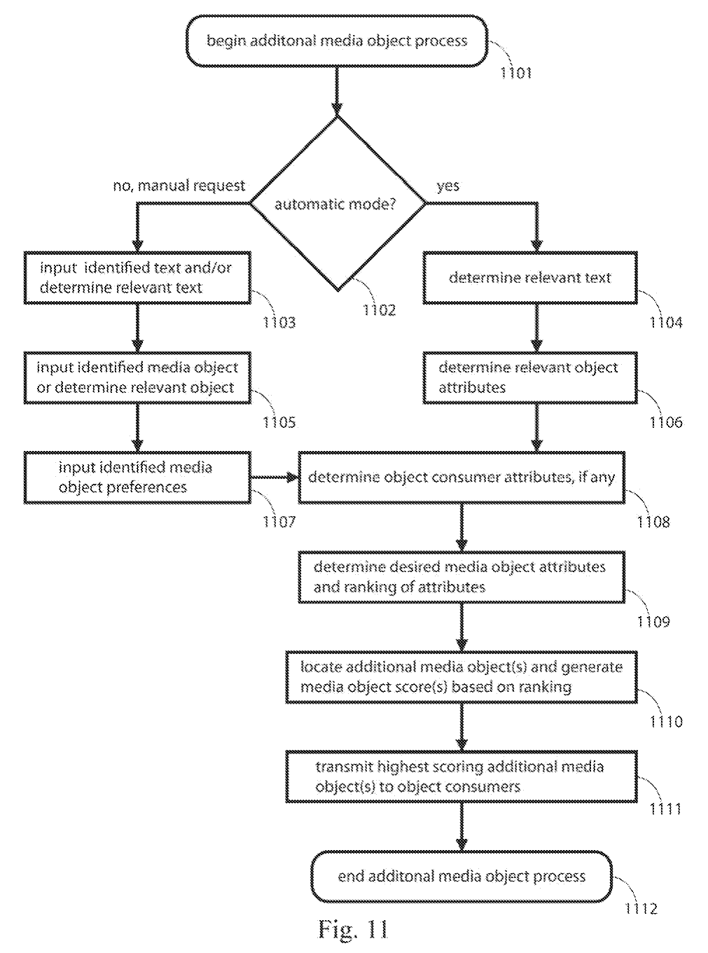

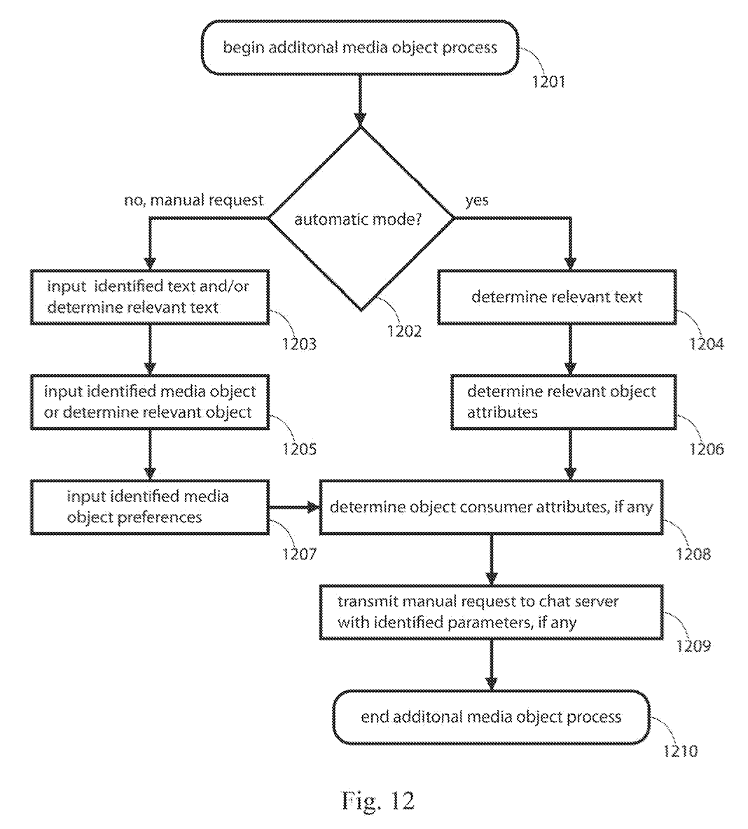

As mentioned above, the enhancement mechanisms rely on background processes to find and transmit additional media objects. The background processes rely on the interaction of a number of interconnected processes described as follows. FIG. 10 is an example flowchart for media server 509 processing an example media object request such as that generated by chat server 503. FIG. 11 is an example flowchart for chat server 503 in generating a service request to media server 509. FIG. 12 is an example flowchart for a chat client, such as a chat client residing on user device 501 or 306, in generating a service request to chat server 503. Each flowchart consists of a plurality of numbered steps.

Referring to FIG. 10, the media server 509 begins to process a request by determining whether the request is for a specific media object or a request for a list of accessible media objects with one or more specified attributes in step 1002.

If the media server request is for a specific object, the media object identifier is input in step 1004, and the user access privileges are input in step 1006. Media server 509 determines whether the identified media object resides in the media server database, and if so, whether the user has access privileges to the media object. If both of these conditions are satisfied, the media server 509 accesses media object database 511 to output the requested media object in a transmission to the requester. Otherwise, the media object is inaccessible, and the media server 509 transmits an appropriate error message to the requester.

If the media server request is for a list of object(s) with specified attributes, the flowchart proceeds from step 1002 to step 1003 to input the desired attributes. Media server 509 determines whether the specified attributes are linked to contained media object(s) in media descriptor database 510. If so, media server 509 generates a list of identifiers of the contained media object(s). The generated list is empty if no media objects are found. In step 1007 the list is checked. If empty, the flowchart proceeds to step 1009, transmitting an appropriate error message to the requester. Otherwise, the non-empty list of media object identifiers is transmitted to the requester.

Referring to FIG. 11, the chat server 503 begins to process a request for additional media objects by determining whether the request is for automatic selection of additional objects or manually influenced selection in step 1102.

If the mode is automatic, chat server 503 determines a portion of the chat messages as the relevant text to use in searching for additional media objects in step 1104. As explained above, the relevant text may be based on the whole chat history or one or more recent chat messages. In step 1106, chat server 503 determines a relevant media object, if any, and if necessary, polls media server 509 to determine the relevant media object attributes.

If the mode is manual, the flowchart proceeds from step 1102 to step 1103. Chat server 503 inputs chat text identified by the requester as relevant, if any, and/or identifies relevant chat text in step 1103. Chat server 503 inputs a media object identified by the requester as relevant, if any, and/or identifies a relevant media object, if any, in step 1105. Step 1107 inputs any additional media object preferences determined by the users.

In step 1108, the object consumer attributes relevant to media object selection are determined. Said attributes may include privileges for the consumer as well as restrictions for the consumer. An example of a privilege is access to media objects based on a paid subscription to an online service. Example restrictions include selection of media objects appropriate for the age and geographic location of the consumer.

In step 1109, the search parameters are combined to determine a set of desired media object attributes and their relative ranking. In step 1110, chat server 503 locates additional media object(s) with the desired attributes. If necessary, chat server 503 polls one or more media servers such as 509 to determine media objects with the desired attributes. In an alternative embodiment, chat server 503 may periodically poll available media object servers to replicate and locally store one or more of a database of media attributes in database 507, relative ratings of various media objects to associated attributes in database 508, and locations of additional media objects in media server database 506. Each additional media object is assigned a score related to correlation with the various desired media object attributes. Media object(s) with highest scores are transmitted as output to the object consumers in step 1111.

In one embodiment of the invention, a chat client application forwards a request for additional media objects to chat server 503, which processes the request as shown in FIG. 11. In an alternative embodiment, the chat client application performs a number of local pre-processing steps to offload demand on the chat server. This is shown in FIG. 12, an example flowchart for an enhancing chat client program. Steps 1202 to 1208 are the same as steps 1102 to 1108 in FIG. 11, but are performed locally on the client device. These steps identify a number of parameters in an additional media object request. The identified parameters are forwarded with a manual enhancement request to chat server 503.

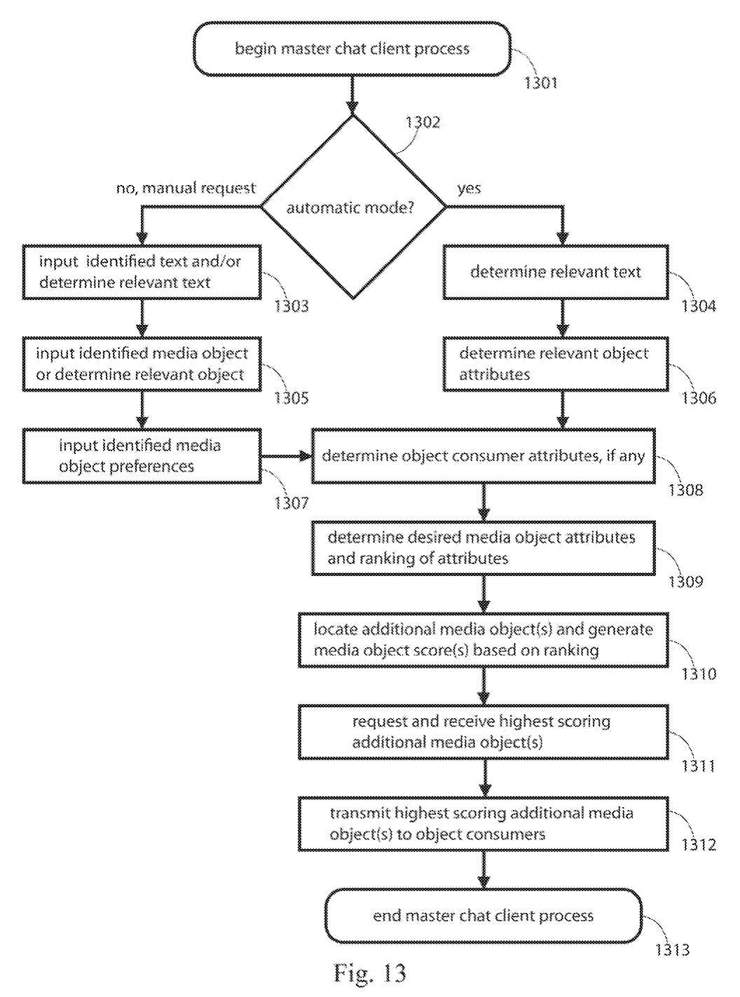

In some applications, demand on a chat server is further reduced by establishing a direct point-to-point transmission protocol for instant message exchanges between two or more users. In a typical instant messaging implementation, users initially establish a connection through a chat server operative to maintain a database of users presently online, sometimes referred to as a presence server. For example, user 502 may initiate a chat session through the presence server to user 309. Once the session has been initiated, the presence server supplies parameters as required to facilitate direct point-to-point communication between each of the two user's chat clients, without further intervention from the chat server. In such an application, the enhancement mechanism is modified to replace chat server functions with functions to be performed on the client device. An alternate embodiment of the enhancement mechanism for point-to-point communication is provided by the example flowchart of FIG. 13.

Referring to FIG. 13, one participant in a chat session is considered the master of each enhancement. In an example embodiment, one user is designated as the master client when the chat is established. In an alternative embodiment, the master client alternates between the users in a chat session. The master user's device executes software code instructions to perform a number of steps 1301-1310 which offload the same steps 1101-1110 performed by the chat server in FIG. 11. In step 1311, the master chat client software code initiates a direct request to media server(s) to supply the additional media object(s). In step 1312, the additional media objects are transmitted to subservient chat participants.

While a number of exemplary aspects and embodiments have been discussed above, those of skill in the art will recognize certain modifications, permutations, additions and sub-combinations thereof. It is therefore intended that the following appended claims and claims hereafter introduced are interpreted to include all such modifications, permutations, additions and sub-combinations as are within their true spirit and scope.

What is claimed is:

1. A method comprising
accessing one or more attributes of one or more real-time interactive messages in an instant messaging session over a communications network between two or more client applications;
interacting with one or more remote host systems to identify one or more media objects to associate with the one or more attributes;
determining one or more locations of the one or more identified media objects in one or more data storage systems;
retrieving, from the one or more determined locations in one or more data storage systems, the one or more media objects; and
distributing the one or more additional media objects among the network client applications in one or more data packets operative to cause the network client applications to render the one or more media objects within the context of the chat or instant messaging session.

2. The method of claim 1, wherein the one or more attributes include one or more of phrases of message text.

3. The method of claim 1, wherein the one or more attributes include one or more entries related to a message composer, indicating one or more of the message composer identifier, a set of one or more preferences for the message composer, a set of one or more access privileges for the message composer, a geographic locater for the message composer, an age of the message composer, and a set of media object players accessible to the message composer; and wherein the associating of one or more media objects is biased by one or more entries related to the message composer.

4. The method of claim 1, wherein, for each of one or more message consumers, the one or more attributes include one or more entries related to the message consumer, indicating one or more of the message consumer identifier, a set of one or more preferences for the message consumer, a set of one or more access privileges for the message consumer, a geographic locater for the message consumer, an age of the message consumer, and a set of media object players accessible to the message consumer; and wherein the associating of one or more media objects is biased by one or more entries related to the message consumer.

5. The method of claim 1, wherein the encapsulated one or more data objects further includes computer-readable instructions operative to cause the client application to define one or more media object players to convey the one or more media objects, and optionally retrieve one or more software code modules corresponding to the one or more media object players.

6. The method of claim 1, further comprising
correlating the one or more message attributes with one or more entries of media object metadata;
determining one or more most correlated entries of media object metadata;
using, as keywords, the one or more most correlated entries of media object metadata;
ranking the relative importance of the one or more keywords;
accessing one or more rating attributes of one or more media objects tagged with one or more of the one or more keywords;
combining the rating and ranking attributes to determine a priority of the media objects tagged with one or more of the one or more keywords; and
identifying the one or more highest priority media objects as the one or more most associated media objects.

7. The method of claim 1, further comprising
accessing one or more attributes of one or more media object consuming users;
determining access privileges for the one or more consuming users from the one or more attributes;
determining which of the associated media objects the media object consuming users have privilege to access; and
restricting access to one or more media objects to enforce the consuming user access privileges.

8. An apparatus comprising
a memory;
one or more network interfaces;
one or more processors; and
an instant message hosting application physically stored in the memory;
said apparatus operative to:
access one or more attributes of one or more real-time interactive messages in an instant messaging session over a communications network between two or more client applications;
interact with one or more remote host systems to identify one or more media objects to associate with the one or more attributes;
determine one or more locations of the one or more identified media objects in one or more data storage systems;
retrieve, from the one or more determined locations in one or more data storage systems, the one or more media objects;
distribute the one or more media objects among the network client applications in one or more data packets operative to cause the network client applications to render the one or more media objects within the context of the chat or instant messaging session.

9. The apparatus of claim 8, wherein the one or more attributes include one or more of phrases of message text.

10. The apparatus of claim 8, wherein the one or more attributes include one or more entries related to a message composer, indicating one or more of the message composer identifier, a set of one or more preferences for the message composer, a set of one or more access privileges for the message composer, a geographic locater for the message composer, an age of the message composer, and a set of media object players accessible to the message composer; and wherein the apparatus is further operative to bias the identification of one or more media objects using one or more entries related to the message composer.

11. The apparatus of claim 8, wherein, for each of one or more message consumers, the one or more attributes include one or more entries related to the message consumer, indicating one or more of the message consumer identifier, a set of one or more preferences for the message consumer, a set of one or more access privileges for the message consumer, a geographic locater for the message consumer, an age of the message consumer, and a set of media object players accessible to the message consumer; and wherein the apparatus is further operative to bias the identification of one or more media objects using one or more entries related to the message composer.

12. The apparatus of claim 8, wherein the encapsulated one or more data objects further includes computer-readable instructions operative to cause the client application to define one or more media object players to convey one or more media objects, and optionally retrieve one or more software code modules corresponding to the one or more media object players.

13. The apparatus of claim 8, wherein the apparatus is further operative to:
correlate the one or more message attributes with one or more entries of media object metadata;
determine one or more most correlated entries of media object metadata;
use, as keywords, the one or more most correlated entries of media object metadata;
rank the relative importance of the one or more keywords;
access one or more rating attributes of one or more media objects tagged with one or more of the one or more keywords;
combine the rating and ranking attributes to determine a priority of the media objects tagged with one or more of the one or more keywords; and
identify the one or more highest priority media objects as the one or more most associated media objects.

14. The apparatus of claim 8, wherein the apparatus is further operative to:
access one or more attributes of one or more media object consuming users;
determine access privileges for the one or more consuming users from the one or more attributes;
determine which of the associated media objects the media object consuming users have privilege to access; and
restrict access to one or more media objects to enforce the consuming user access privileges.

15. A method comprising
accessing one or more attributes of one or more real-time interactive messages in an instant messaging session over a communications network between two or more other client applications;
interacting with one or more remote server systems to retrieve one or more media objects associated with the one or more keywords;
transmitting the one or more media objects to at least one of the network client applications in one or more data packets operative to cause the network client applications to render the one or more media objects within the context of the chat or instant messaging session.

16. The method of claim 15, further comprising
negotiating with a remote user client application in an instant messaging session over a communications network between two or more other client applications to identify a master node for distributing media objects to other client applications in the instant messaging session.

17. A user interface comprising
an interactive user display and input system for a user sharing messages with one or more other users in a messaging session over a communications network, including
a composition area where the composing user may enter text to compose a new message for the other users;
a session history area where text messages shared among the user and the other users are displayed; and
one or more media object player interfaces conveying one or more shared media objects related to the shared text messages.

18. The user interface of claim 17, further including one or more of
a media object preference interface control where the composing user may indicate attributes to bias the identification of one or more media objects;
a media object player interface to preview one of the identified media object;
when more than one media object is identified, one or more user interface controls to change the media object previewed on the media object player; and
one or more user interface controls to select a particular identified media object to share.

19. The user interface of claim 17, wherein each of the one or more media object player interfaces are embedded near the one or more related text messages in the session history area.

20. The user interface of claim 17, wherein a media object player interface includes a user controlled scrolling mechanism to review the history of shared media objects.
